(19) United States
(12) Patent Application Publication
(10) Pub. No.: US 2007/0266103 A1
(43) Pub. Date: Nov. 15, 2007

(54) Television messaging system with identification function

(75) Inventor: Hsiu-Wen Cheng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/476,087

(22) Filed: Jun. 28, 2006

(30) Foreign Application Priority Data
Apr. 10, 2006 (TW) 095112682

(51) Int. Cl. G06F 15/16

(52) U.S. Cl. 709/206

(57) ABSTRACT

A television messaging system with identification function is provided. To create a message, the person who leaves a message inputs and stores his/her identity information, a message, and the identity information of the person whom the message is for through the user interface in the database; to obtain a message, the user inputs his/her identification through the user interface. Then, the microprocessor searches for the matched identification in the database, and then shows the corresponding message on the display device and plays it through the speaker. Therefore, the television messaging system with identification function enhances the functionality and the value of a television, and also provides individuality and privacy in management of a messaging system.

### BACKGROUND OF THE INVENTION

1. Field of the Invention

The present invention relates to a messaging system and, more particularly, to a messaging system with identification function.

2. Description of the Related Art

Nowadays, people of all ages and both sexes are mostly busy with their own lives and works; even the family members hardly see each other. If someone has an emergency and needs to contact the family members or friends, but there is no one at home and the person concerned cannot be reached at the moment, it may cause delays in handling important matters. To solve this problem, the industry provides many convenient ways of communication, such as text messages, phone calls, or voice mails, for people to contact their families or to keep in touch with their friends.

Additionally, television is the basic entertainment system, which is commonly owned by most families. Following by the advancement of technology, the functionalities provided by the television become diversified. Besides displaying images and playing sounds, a prior art television may also have the function of voice messages, but its voice messaging system did not have the function of recognizing and distinguishing the person who listens to the messages, which lacked individuality and privacy. In order to obviate the aforementioned problems, the television messaging system with identification function of present invention provides an improved voice messaging management to establish a preferred television messaging system.

### SUMMARY OF THE INVENTION

In the present invention, the television messaging system with identification function comprises a display device, a speaker, a user interface, a database, and a microprocessor. The user interface receives at least one message; the database pre-stores several user identity information to save received messages; the microprocessor controls the user interface, the display device, the speaker, and the database.

To create a message, the person who leaves a message inputs his/her own identity information, a message, and the identity information of a person, whom the message is intended for, through the user interface, and then the inputted information is stored in the database. To obtain a message, the person who listens to the message inputs his/her own identification through the user interface. Then, the microprocessor searches for the matched identification in the database, and displays the corresponding message on the display device and through the speaker.

Thus, aforesaid television messaging system with identification function provides an improved individuality and privacy of the managing mechanism for the user.

Further, the aforesaid television message system with identification function comprises a remote control which is connected wirelessly to the user interface for inputting data or manipulating instructions.

The aforesaid television message system with identification function comprises a keypad; the keypad connects to the user interface for inputting data or manipulating instructions.

The aforesaid television message system with identification function comprises a storage device; the storage device connects to the user interface and saves at least one message which is read by the microprocessor and saved in the database.

The aforesaid television message system with identification function comprises a microphone which connects to the user interface for inputting a voice message.

### BRIEF DESCRIPTION OF THE DRAWINGS

FIG. 1 is a systemic structure of the preferred embodiment in the present invention;

FIG. 2 is a perspective view of the present invention;

FIG. 3 is a flow chart for setting up an user identification of the preferred embodiment in the present invention;

FIG. 4 is a flow chart for creating a message in the preferred embodiment of the present invention; and

FIG. 5 is flow chart for obtaining message in the preferred embodiment of the present invention.

### DETAILED DESCRIPTION OF THE PREFERRED EMBODIMENT

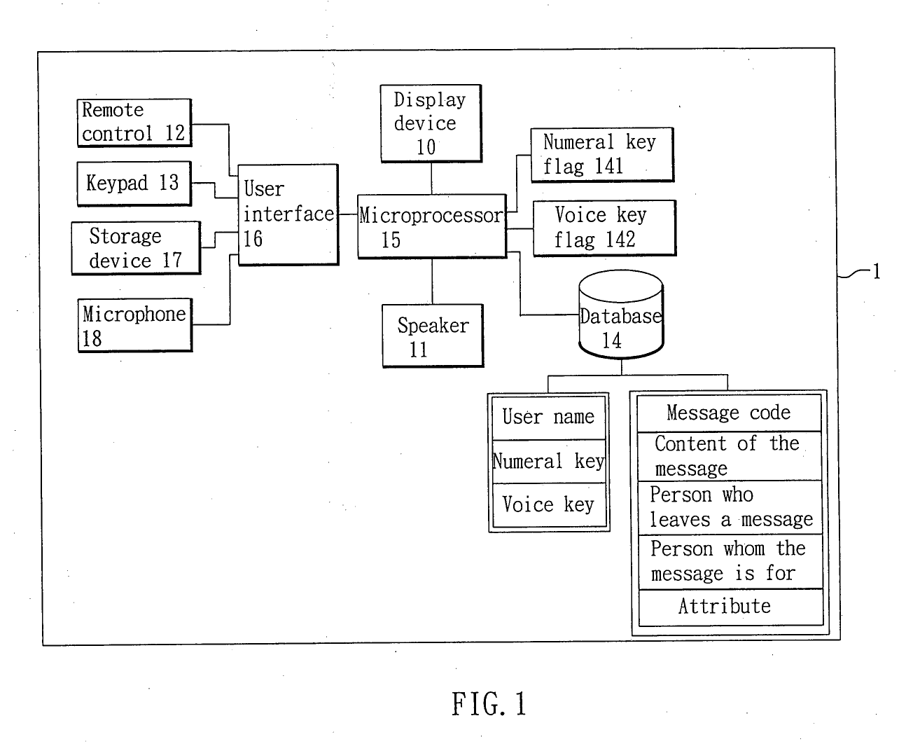

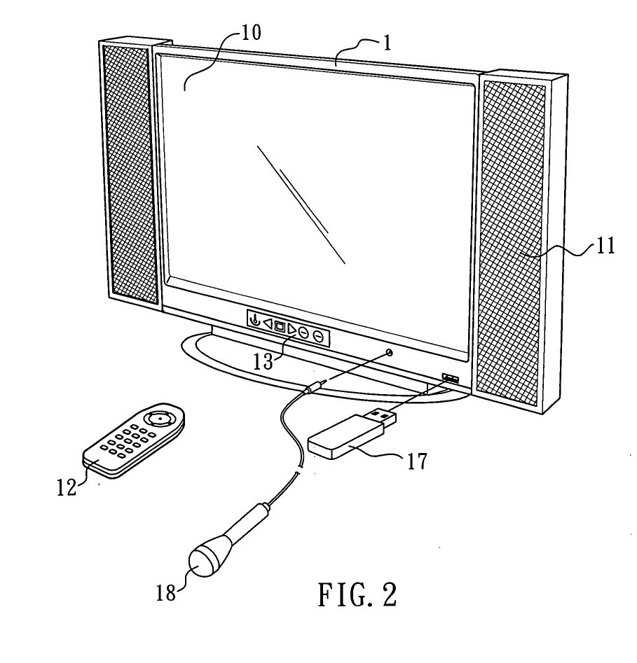

In relation to the messaging system with identification function of the preferred embodiment, please refer to FIG. 1, a systemic structure, and FIG. 2, a perspective view of the present invention. The television messaging system with identification function 1 of the present invention includes a display device 10, a speaker 11, a remote control 12, a keypad 13, a database 14, a microprocessor 15, a user interface 16, a storage device 17, and a microphone 18.

In this preferred embodiment, the user interface 16 receives at least one message; the remote control 12 and the keypad 13 respectively have wireless and wired connection with the user interface 16 for inputting data or manipulating instructions; the database 14 pre-saves a plurality of user identity information which includes a user name, a numeral key and a voice key in order to store the message received; the microprocessor 15 controls the user interface 16, the display device 10, the speaker 11, and the database 14; the storage device 17 connects to the user interface 16 and stores at least one message which is read through the microprocessor 15 and saved in the database 14; the microphone 18 connects to the user interface 16 for inputting a voice message.

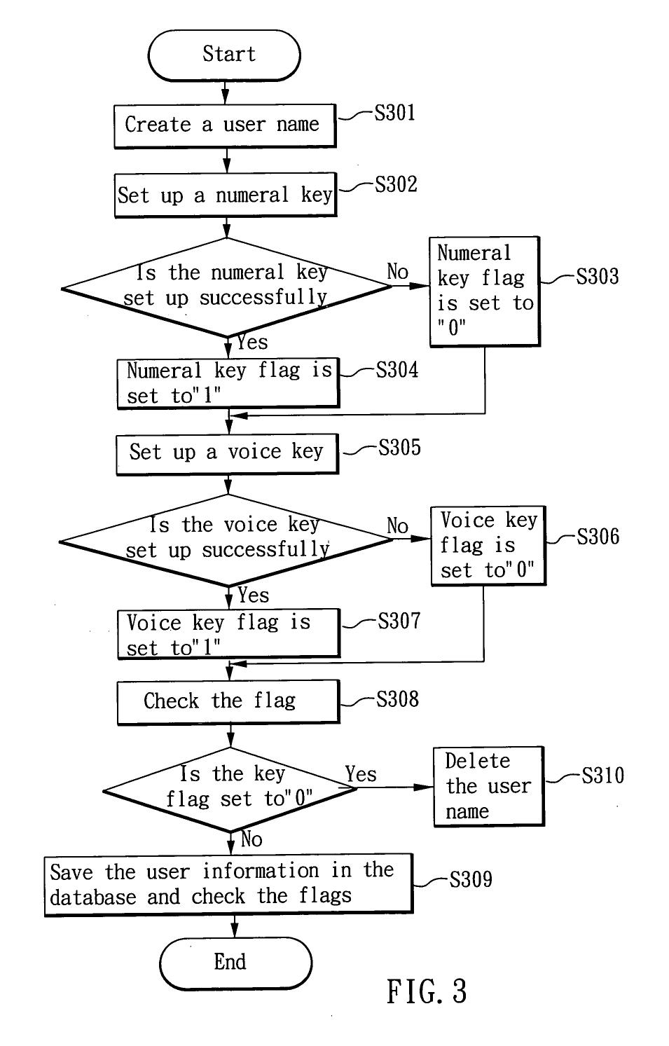

Referring to FIG. 3, using the television messaging system with identification function for the first time, the user chooses the option of “creating a user identity” on the user interface 16 in order to create a identity information. First, the user inputs a user name, such as mom, dad, son, or daughter by using the remote control 12 or the keypad 13, as step S301 in FIG. 3. Then, the user sets a numeral key such as “1234”, as step S302, or sets a voice key, for instance, “happy family”, as step S305. If one of the keys is not set up successfully, the microprocessor 15 will set the value of the corresponding numeral key flag 141 or voice key flag 142 to “0”, as step S303 and step S306. In contrast, if one of the keys is set up successfully, the microprocessor 15 will set the value of the corresponding numeral key flag 141 or voice key flag 142 to “1”, as step S304 and step S307. Then, the microprocessor 15 checks the values of numeral key flag 141 and voice key flag 142. If one of the key flag values is “1”, the microprocessor 15 will saves the corresponding identity information in the database 14 to create a user identity, as step S309; if the value of the numeral key flag 141 or the voice key flag 142 is “0”, the microprocessor will delete the identity information to cancel the process of creating a user identity.

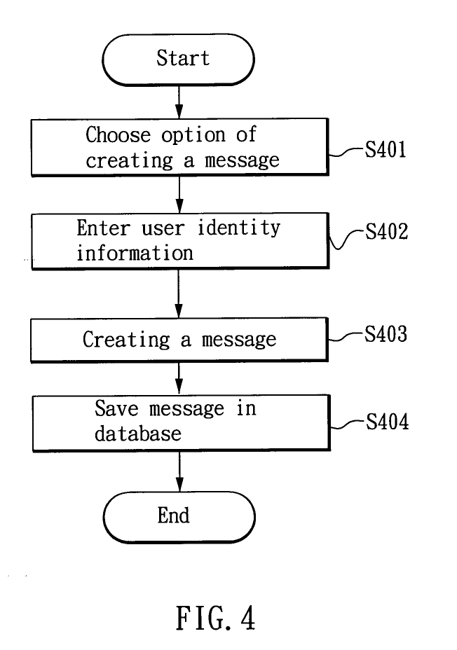

FIG. 4 is a flow chart for creating a message in the preferred embodiment of the present invention. To create a message, the person who leaves a message, chooses the option of “creating a message” on the user interface 16 in order to proceed with creating a message (step S401). After he/she enters the user name, and numeral key or voice key, the microprocessor 15 searches the pre-saved user identity information to check whether the numeral key or voice key entered matches the user name in order to confirm the identity of the user (Step S402). After the confirmation of user identity, the messaging system then allows the user to create a message (step S403) and saves the message in the database 14 (step S404). In the present invention, the message includes a message code, content of the message, an attribute, and corresponding identity information of the one who leaves the message and the person whom the message is left to. Additionally, the content of the message is a text message or a voice message; the attribute of the message is whether the message is valid or not and whether the message can be deleted or not.

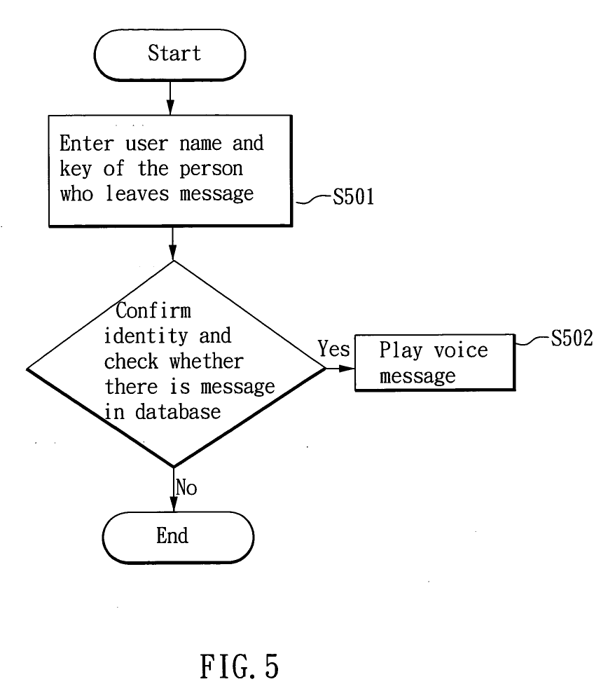

FIG. 5 is flow chart for obtaining message in the preferred embodiment of the present invention. To obtain a message, the user enters his/her identity information through the user interface 16, and then the microprocessor 15 searches for the matched user identity in the database 14 and checks whether the numeral code or the voice code entered matches the user name in order to confirm his/her identity. After confirming the identity, the microprocessor 15 searches for the matching identity information in the database and shows the corresponding message on the display device 10 or plays it on the speaker 11 (step S502).

As known in the aforesaid specification, the present invention makes good use of the television which is own in almost every family to provide an improved messaging system. When someone tries to leave a message or to listen to a message left by the other family members, the person only has to enter the identity information in the messaging system, and after the system confirmed the identity, then the person can create a message or obtain a message. Therefore, a messaging systemic management providing individuality and privacy can reduce the estranged feelings resulted from fewer meetings.

Although the present invention has been explained in relation to its preferred embodiment, it is to be understood that many other possible modifications and variations can be made without departing from the scope of the invention as hereinafter claimed.

What is claimed is:

1. A television messaging system with identification function, comprising:
a display device;
a speaker;
a user interface, which receives at least one message;
a database, which pre-stores several user identity information to save received messages; and
a microprocessor, which controls the user interface, the display device, the speaker, and the database;
wherein, in order to create a message, a person who leaves a message inputs and saves his/her identity information, a message, and the identity information of a person, whom the message is for, through the user interface to the database; in order to obtain a message, a person who listens to a message inputs his/her identity information through the user interface, then the microprocessor matches the inputted identification in the database and displays the corresponding message on the display device and through the speaker.

2. The television messaging system with identification function as claimed in claim 1, wherein the user information includes a user name, a numeral key and a voice key.

3. The television messaging system with identification function as claimed in claim 2, wherein the message including a message code, a message content, an attribute, and corresponding identities of the person who leaves a message and the person whom the message is for.

4. The television messaging system with identification function as claimed in claim 3, wherein the message content is a test message or a voice message.

5. The television messaging system with identification function as claimed in claim 3, wherein the attribute of the message is that whether the message is valid or not and whether the message can be deleted or not.

6. The television messaging system with identification function as claimed in claim 3, wherein the identity information required includes a user name, and either numeral key or voice key, then the microprocessor searches the pre-saved user identity information in the database to compare and match the inputted numeral key or voice key with the user name entered, in order to confirm the identity of the user.

7. The television messaging system with identification function as claimed in claim 1, further comprising a remote control connected wireless to the user interface for inputting data or manipulating instructions.

8. The television messaging system with identification function as claimed in claim 1, further comprising a keypad connected to the user interface for inputting data or manipulating instructions.

9. The television messaging system with identification function as claimed in claim 1, further comprising a storage device which is connected to the user interface, the storage device stores at least one message which is inputted through the microprocessor and stored in the database.

10. The television messaging system with identification function as claimed in claim 1, further comprising a microphone which is connected to the user interface for inputting a voice message.
